(19) United States
(12) Patent Application Publication
(10) Pub. No.: US 2018/0202524 A1
(43) Pub. Date: Jul. 19, 2018

(54) LINEAR ACTUATOR STRUCTURE

(71) Applicant: J-STAR MOTOR INDUSTRIAL CO., LTD., Taipei City (TW)

(72) Inventor: Wei-Fan WU, Taichung City (TW)

(21) Appl. No.: 15/841,315

(22) Filed: Dec. 14, 2017

(30) Foreign Application Priority Data
Jan. 19, 2017 (TW) 106200977

(51) Int. Cl. F16H 25/20

(52) U.S. Cl. CPC F16H 25/2056

(57) ABSTRACT

The present disclosure provides a linear actuator structure including a first tube, a second tube, a third tube, and a rotating shaft. The first tube has a central screw rod, wherein the central screw rod is disposed in the first tube. The second tube has a linking screw rod, wherein the linking screw rod is disposed in the second tube, and the linking screw rod is linked-up with the central screw rod penetrating the linking screw rod. The rotating shaft is linked-up with the linking screw rod. The third tube is screwed by the linking screw rod and sleeves the rotating shaft. When the rotating shaft rotates, the linking screw rod is driven to rotate to synchronously move the second tube and the first tube to lengthen or shorten the linear actuator structure.

### RELATED APPLICATIONS

This application claims priority to Taiwan Application Serial Number 106200977, filed Jan. 19, 2017, which is herein incorporated by reference.

### BACKGROUND

### Technical Field

The present disclosure relates to a linear actuator structure. More particularly, the present disclosure relates to a linear actuator structure having three tubes that can be synchronously moved.

### Description of Related Art

For improving the usage convenience of users, some of the furniture (such as chairs or tables) will be disposed with several height adjusting mechanisms implemented as the legs of the furniture for adjusting the height of the furniture. Conventionally, a height adjusting mechanism is made of a screw rod driven by a rotating shaft and a fixed tube with inner threads matched to the screw rod. When the rotating shaft rotates to drive the screw rod to rotate, the screw rod screws in or out of the fixed tube to shorten or lengthen the total length of the height adjusting mechanism, such that the height of the furniture may be raised or lowered.

However, if the rotating shaft is driven by a single motor, the numbers of the threads on the screw rod and related gears will be significantly increased, and the screw rod has to be used, which increases the overall size. On the other hand, if the rotating shaft is driven by multiple motors, the overall size will be increased while raising the manufacturing cost. Moreover, the control means will be complicated and easy to be damaged.

Therefore, it is important to design a new height adjusting mechanism with smaller size and lower cost.

### SUMMARY

The present disclosure provides a linear actuator structure including a first tube, a second tube, a third tube, and a rotating shaft. The first tube has a first end, a second end, and a central screw rod, wherein the central screw rod is disposed in the first tube and engaged to the first end of the first tube. The second tube has a first end, a second end, and a linking screw rod, wherein the linking screw rod is disposed in the second tube and against the first end of the second tube, and the linking screw rod is linked-up with the central screw rod penetrating the linking screw rod via the second end of the first tube and the first end of the second tube. The rotating shaft is linked-up with the linking screw rod. The third tube has a first end and a second end, wherein the first end of the third tube is screwed by the linking screw rod penetrating the second end of the second tube, and the second end of the third tube sleeves the rotating shaft. When the rotating shaft rotates, the linking screw rod is driven to rotate to synchronously move the second tube and the first tube to lengthen or shorten the linear actuator structure.

The present disclosure provides a linear actuator structure including a first tube, a second tube, a third tube, and a driving element. The first tube has a first end, a second end, and a central screw rod, wherein the second end of the first tube is opened, and the central screw rod is disposed in the first tube and engaged to the first end of the first tube. The second tube has a first end, a second end, a hollowed screw rod, and a first transition element, wherein the first end of the second tube is sleeved by the first tube via the second end of the first tube and disposed with a first opening, the hollowed screw rod is disposed in the second tube and connected with the first end of the second tube via the first transition element screwed by the central screw rod penetrating the hollowed screw rod via the first opening, and the second end of the second tube is opened. The driving element has a rotating shaft disposed therein, wherein the rotating shaft penetrates the hollowed screw rod via the second end of the second tube and drives the hollowed screw rod to rotate therewith. The third tube has a first end and a second end, wherein the first end of the third tube is sleeved by the second tube via the second end of the second tube and disposed with a second opening screwed by the hollowed screw rod, the second end of the third tube is fixed to the driving element for the rotating shaft to rotate in the third tube. When the rotating shaft rotates, the hollowed screw rod is driven to rotate to synchronously move the second tube and the first tube to lengthen or shorten the linear actuator structure.

### BRIEF DESCRIPTION OF THE DRAWINGS

The present disclosure can be more fully understood by reading the following detailed description of the embodiment, with reference made to the accompanying drawings as follows:

FIG. 1 is a partially perspective view of a linear actuator structure of one embodiment of the present disclosure;

FIG. 2A is a cross-sectional view of where the first tube and the second tube are assembled according to one embodiment of the present disclosure;

FIG. 2B is an exploded view of a part of FIG. 2A;

FIG. 3A is a cross-sectional view of where the second tube and the third tube are assembled according to one embodiment of the present disclosure;

FIG. 3B is an exploded view of a part of FIG. 3A;

FIG. 4 is a schematic diagram illustrating the linear actuator structure being shortened;

FIG. 5 is a partially perspective view of a linear actuator structure of one embodiment of the present disclosure;

FIG. 6 is a cross-sectional view of the linear actuator structure according to one embodiment of the present disclosure;

FIG. 7 is an exploded view of the linear actuator structure;

FIG. 8A is a schematic diagram of shortening the linear actuator structure;

FIG. 8B is a schematic diagram of lengthening the linear actuator structure; and

FIG. 9 is a schematic diagram illustrating the linear actuator structure being shortened.

### DETAILED DESCRIPTION

Various examples of the devices introduced above will now be described in further detail. The following description provides specific details for a thorough understanding and enabling description of these examples. One skilled in the relevant art will understand, however, that the techniques discussed herein may be practiced without many of these details. Likewise, one skilled in the relevant art will also understand that the technology can include many other features not described in detail herein. Additionally, some well-known structures or functions may not be shown or described in detail below so as to avoid unnecessarily obscuring the relevant description.

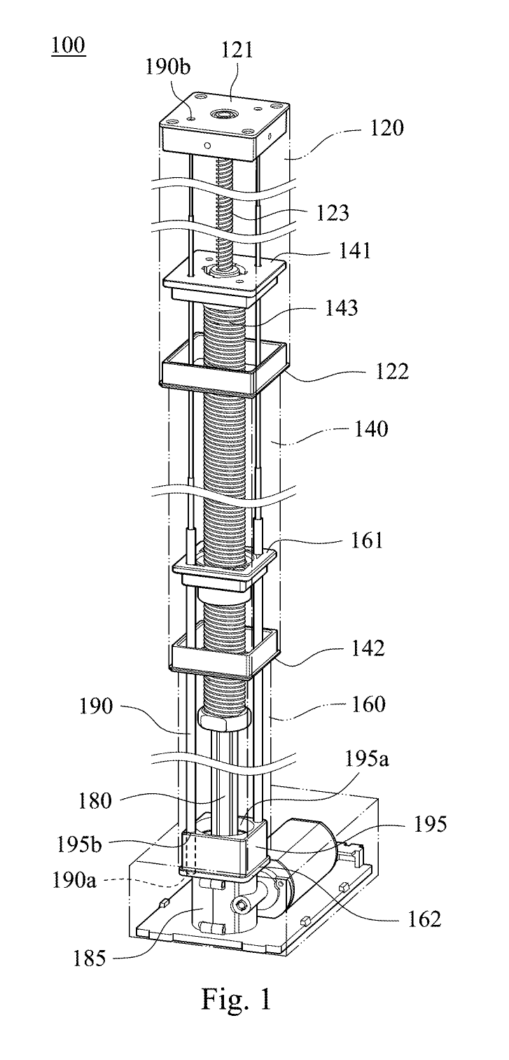

See FIG. 1, which is a partially perspective view of a linear actuator structure 100 of one embodiment of the present disclosure. In FIG. 1, the linear actuator structure 100 includes a first tube 120, a second tube 140, a third tube 160, and a rotating shaft 180. The first tube 120 has a first end 121, a second end 122, and a central screw rod 123, wherein the central screw rod 123 is disposed in the first tube 120 and engaged to the first end 121 of the first tube 120.

The second tube 140 has a first end 141, a second end 142, and a linking screw rod 143, wherein the linking screw rod 143 may be a hollowed screw rod disposed in the second tube 140 and against the first end 141 of the second tube 140, and the linking screw rod 143 is linked-up with the central screw rod 123 penetrating the linking screw rod 143 via the second end 122 of the first tube 120 and the first end 141 of the second tube 140.

The rotating shaft 180 is linked-up with the linking screw rod 143. The third tube 160 has a first end 161 and a second end 162, wherein the first end 161 of the third tube 160 is screwed by the linking screw rod 143 penetrating the second end 142 of the second tube 140, and the second end 162 of the third tube 160 sleeves the rotating shaft 180. In the present embodiment, a driving element 185 (e.g., a single motor) may be included for the rotating shaft 180 to dispose thereon, and the second end 162 of the third tube 160 is fixed to the driving element 185 for the rotating shaft 180 to rotate in the third tube 160.

Moreover, a telescopic antenna 190 may be included. The telescopic antenna 190 may be sleeved by the third tube 160 and has a first end 190a and a second end 190b, wherein the first end 190a of the telescopic antenna 190 is connected with the driving element 185, the second end 190b of the telescopic antenna 190 is connected with the first end 121 of the first tube 120, and the telescopic antenna 190 is shortened or lengthened along with the linear actuator structure 100 shortens or lengthens. Specifically, the telescopic antenna 190 may be used to replace conventional electrical lines which are difficult to be disposed within the linear actuator structure 100 that is capable of being lengthened or shortened. Accordingly, the manufacture of the linear actuator structure 100 may be simplified, and the inner configuration of the linear actuator structure 100 may become neater.

Further, a damping base 195 may be included. The damping base 195 may be disposed on the driving element 185 and has a central though hole 195a and a limiting slot 195b, wherein the central through hole 195a accommodates the rotating shaft 180, and the limiting slot 195b is fitted by the telescopic antenna 190, but the present disclosure is not limited thereto.

In one embodiment, when the rotating shaft 180 rotates, the linking screw rod 143 is driven to rotate to synchronously move the second tube 140 and the first tube 120 to lengthen or shorten the linear actuator structure 100. Details of the linear actuator structure 100 will be provided in the following paragraphs.

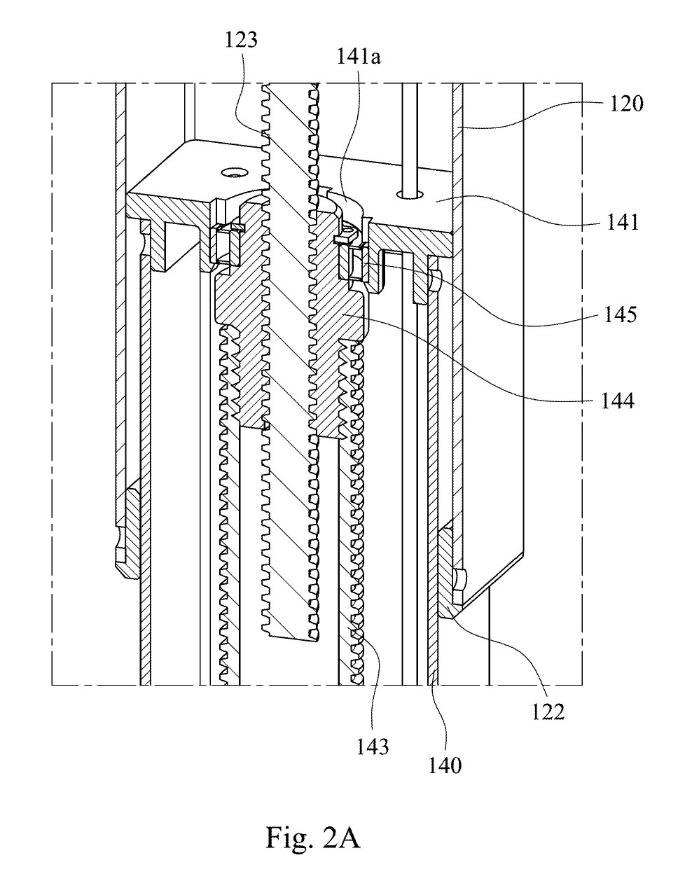

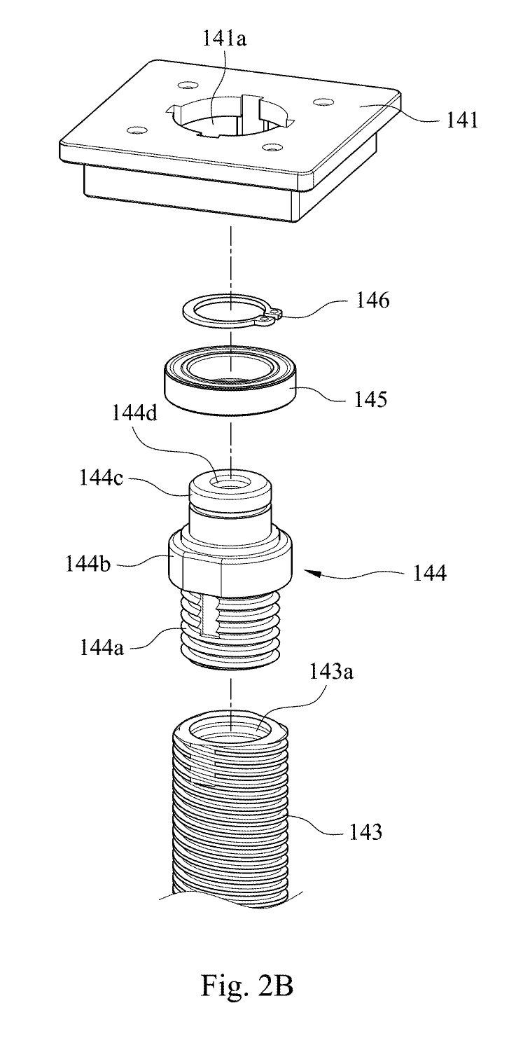

See FIG. 2A and FIG. 2B, wherein FIG. 2A is a cross-sectional view of where the first tube 120 and the second tube 140 are assembled according to one embodiment of the present disclosure, and FIG. 2B is an exploded view of a part of FIG. 2A. In FIG. 2A and FIG. 2B, the second end 122 of the first tube 120 may be opened, and the first end 161 of the second tube 160 is sleeved by the first tube 120 via the second end 122 of the first tube 120. The first end 141 of the second tube 140 may be disposed with a first opening 141a for the central screw rod 123 to penetrate through.

In the present embodiment, a transition element 144 may be further included. The transition element 144 is disposed between the first end 141 of the second tube 140 and the linking screw rod 143 and engaged with the linking screw rod 143.

As shown in FIG. 2B, the transition element 144 may include an outer thread 144a, a middle portion 144b, and a protrusion 144c. In the present embodiment, one end of the linking screw rod 143 may be disposed with an inner thread 143a matched with the outer thread 144a, such that the transition element 143 may be screwed in the linking screw rod 143 for the outer thread 144a to be engaged with the inner thread 143a. The middle portion 144b may be connected with the outer thread 144a and against the one end of the linking screw rod 143 after the outer thread 144a is engaged with the inner thread 143a, wherein the middle portion 144b may have a diameter larger than the diameter of the outer thread 144a.

Further, the transition element 144 may be screwed by the central screw rod 123 penetrating the second end 122 of the first tube 120 and the first end 141 of the second tube 140 (i.e., the first opening 141a). Specifically, the protrusion 144c connected with the middle portion 144b may be disposed with an inner thread 144d matched with the central screw rod 123, such that the central screw rod 123 may be screwed in the protrusion 144c.

In addition, a bearing 145 may be further included and disposed between the transition element 144 and the first end 141 of the second tube 140. In one embodiment, the bearing 145 may be fitted and limited in the first opening 141a, and the protrusion 144c may be sleeved by the bearing 145 which is ring-shaped, such that the middle portion 144b may be against the bearing 145. In one embodiment, the bearing 145 may be retained on the protrusion 144c with a C-shaped retaining ring 146. The bearing 145 may facilitate the rotation of the transition element 144 without abrading the first end 141 of the second tube 140, but the present disclosure is not limited thereto.

In this case, when the linking screw rod 143 is driven by the rotating shaft 180 of FIG. 1 to rotate, the transition element 144 engaged with the linking screw rod 143 will be correspondingly rotated to make the central screw rod 123 passively screw in or out of the transition element 144.

If the central screw rod 123 is passively screwed in the transition element 144, the first end 121 of the first tube 120 may be regarded as being pulled closer to the first end 141 of the second tube 140, which shortens the linear actuator structure 100. On the other hand, if the central screw rod 123 is passively screwed out of the transition element 144, the first end 121 of the first tube 120 may be regarded as being pushed away from the first end 141 of the second tube 140, which lengthens the linear actuator structure 100.

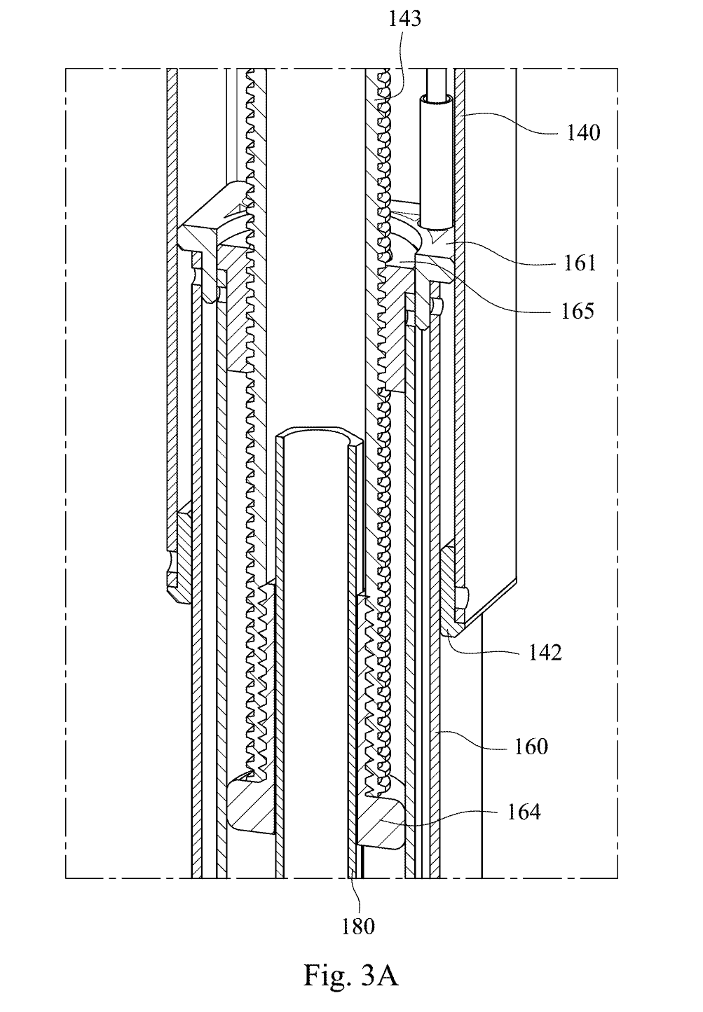

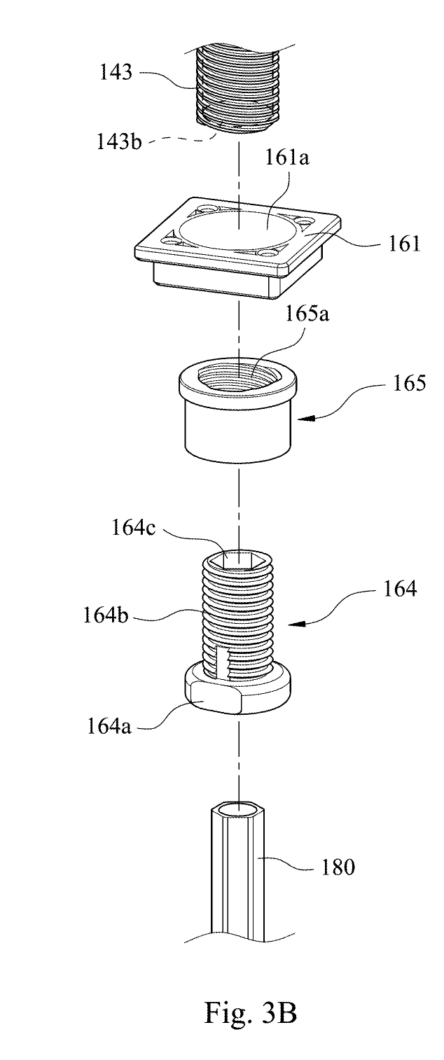

See FIG. 3A and FIG. 3B, wherein FIG. 3A is a cross-sectional view of where the second tube 140 and the third tube 160 are assembled according to one embodiment of the present disclosure, and FIG. 3B is an exploded view of a part of FIG. 3A. In FIG. 3A and FIG. 3B, the first end 161 of the third tube 160 is sleeved by the second tube 140 via the second end 142 of the second tube 140 and disposed with a second opening 161a.

In one embodiment, the second opening 161a may be disposed with inner thread to be screwed by the linking screw rod 143. However, in the present embodiment, the second opening 161a may be fitted by a sleeve 165 having an inner thread 165a and limited in the second opening 161a. In this case, the sleeve 165 limited in the second opening 161a may be screwed by the linking screw rod 143. In yet another embodiment, the sleeve 165 may be integrally formed with the first end 161 of the third tube 160 for the linking screw rod 143 to screw, but the present disclosure is not limited thereto.

As shown in FIG. 3B, a transition bolt 164 may be further included. The transition bolt 164 may be connected between the rotating shaft 180 and the linking screw rod 143. The transition bolt 164 has a head portion 164a, a thread portion 164b, and a through hole 164c.

In the present embodiment, another end of the linking screw rod 143 may be disposed with an inner thread 143b matched with the thread portion 164b, such that the transition bolt 164 may be screwed in the linking screw rod 143 for the thread portion 164b to be engaged with the inner thread 143b. After the thread portion 164b screws in the linking screw rod 143, the head portion 164a may abut the other end of the linking screw rod 143. The through hole 164c may be polygonal-shaped, and the rotating shaft 180 movably penetrates and fits the through hole 164c. In FIG. 3B, the through hole 164c may be hexagonal, and the rotating shaft 180 may be hexagonal, correspondingly. As such, when the rotating shaft 180 rotates, the transition bolt 164 will be driven to rotate, and the linking screw rod 143 engaged with the transition bolt 164 will be correspondingly rotated as well.

In one embodiment, when the rotating shaft 180 rotates along a first direction (e.g., a clockwise direction) to drive the linking screw rod 143 to rotate, the linking screw rod 143 screws in the third tube 160 and correspondingly brings the second tube 140 toward a shortening direction, and the central screw rod 123 synchronously and passively screws in the linking screw rod 143 and correspondingly brings the first tube 120 toward the shortening direction.

In detail, referring back to FIG. 1, as the linking screw rod 143 is driven to rotate along the first direction, it will correspondingly screw the sleeve 165 to move toward the shortening direction (e.g., downward). If the linking screw rod 143 moves downward, the rotating shaft 180 may be regarded as passively pushing into the transition bolt 164 (or into the linking screw rod 143). Meanwhile, the first end 141 of the second tube 140 will be driven to move downward along with the downward movement of the linking screw rod 143. Further, when the linking screw rod 143 is driven to rotate, the transition element 144 engaged with the linking screw rod 143 will be correspondingly rotated to make the central screw rod 123 passively screw into the transition element 144 (or into the linking screw rod 143). Correspondingly, the first end 121 of the first tube 120 will be driven to move downward.

That is, when the rotating shaft 180 rotates along the first direction, the first tube 120 and the second tube 140 will be synchronously moved downward, such that the linear actuator structure 100 may be shortened.

In another embodiment, when the rotating shaft 180 rotates along a second direction (e.g., a counterclockwise direction) to drive the linking screw rod 143 to rotate, the linking screw rod 143 screws out of the third tube 160 and correspondingly brings the second tube 140 toward a lengthening direction, and the central screw rod 123 synchronously and passively screws out of the linking screw rod 143 and correspondingly brings the first tube 120 toward the lengthening direction.

In detail, referring to FIG. 1 again, as the linking screw rod 143 is driven to rotate along the second direction, it will correspondingly screw the sleeve 165 to move toward the lengthening direction (e.g., upward). If the linking screw rod 143 moves upward, the rotating shaft 180 may be regarded as passively pulled out of the transition bolt 164 (or out of the linking screw rod 143). Meanwhile, the first end 141 of the second tube 140 will be driven to move upward along with the upward movement of the linking screw rod 143. Further, when the linking screw rod 143 is driven to rotate, the transition element 144 engaged with the linking screw rod 143 will be correspondingly rotated to make the central screw rod 123 passively screw out of the transition element 144 (or out of the linking screw rod 143). Correspondingly, the first end 121 of the first tube 120 will be driven to move upward.

That is, when the rotating shaft 180 rotates along the second direction, the first tube 120 and the second tube 140 will be synchronously moved upward, such that the linear actuator structure 100 may be lengthened.

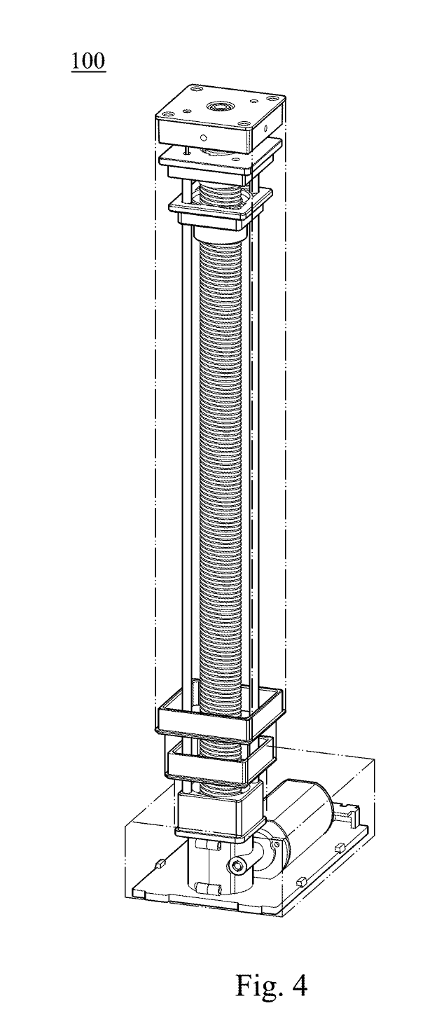

Moreover, in FIG. 1, since the first tube 120 sleeves the second tube 140 via the second end 122 of the first tube 120 and the second tube 140 sleeves the third tube 160 via the second end 142 of the second tube 140, the first tube 120, the second tube 140, and the third tube 160 may be generally regarded as an outer tube, a middle tube, and an inner tube, respectively. In this case, the first tube 120, the second tube 140, and the third tube 160 may be more and more overlapped along with the linear actuator structure being shortened. The linear actuator structure 100 being shortened can be referred to FIG. 4. Alternatively, the first tube 120, the second tube 140, and the third tube 160 may be less and less overlapped along with the linear actuator structure being lengthened.

Accordingly, by disposing the linking screw rod, the linear actuator structure of the present disclosure may be driven by a single driving element, such that the overall structure can be simplified and more robust. Besides, since the first tube, the second tube, and the third tube may be more and more overlapped along with the linear actuator structure being shortened, the overall size and cost can be reduced as well.

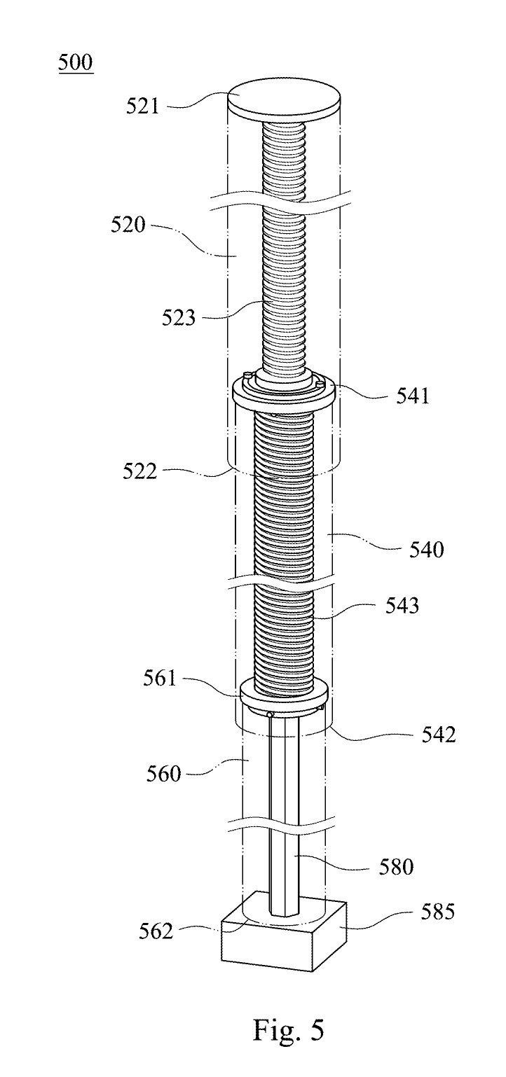

See FIG. 5, which is a partially perspective view of a linear actuator structure 500 of one embodiment of the present disclosure. In FIG. 5, the linear actuator structure 500 includes a first tube 520, a second tube 540, a third tube 560, and a rotating shaft 580. The first tube 520 has a first end 521, a second end 522, and a central screw rod 523, wherein the central screw rod 523 is disposed in the first tube 520 and engaged to the first end 521 of the first tube 520.

The second tube 540 has a first end 541, a second end 542, and a linking screw rod 543, wherein the linking screw rod 543 may be a hollowed screw rod disposed in the second tube 540 and against the first end 541 of the second tube 540, and the linking screw rod 543 is linked-up with the central screw rod 523 penetrating the linking screw rod 543 via the second end 522 of the first tube 520 and the first end 541 of the second tube 540.

The rotating shaft 580 is linked-up with the linking screw rod 543. The third tube 560 has a first end 561 and a second end 562, wherein the first end 561 of the third tube 560 is screwed by the linking screw rod 543 penetrating the second end 542 of the second tube 540, and the second end 562 of the third tube 560 sleeves the rotating shaft 580. In the present embodiment, a driving element 585 may be included for the rotating shaft 580 to dispose thereon, and the second end 562 of the third tube 560 is fixed to the driving element 585 for the rotating shaft 580 to rotate in the third tube 560.

In some embodiments, a telescopic antenna (not shown) such as the telescopic antenna 190 of FIG. 1 may be included. The telescopic antenna may be sleeved by the third tube 560 and has a first end and a second end, wherein the first end of the telescopic antenna is connected with the driving element 585, the second end of the telescopic antenna is connected with the first end 521 of the first tube 520, and the telescopic antenna is shortened or lengthened along with the linear actuator structure 500 shortens or lengthens. As mentioned before, the telescopic antenna may be used to replace conventional electrical lines which are difficult to be disposed within the linear actuator structure 500 that is capable of being lengthened or shortened. Accordingly, the manufacture of the linear actuator structure 500 may be simplified, and the inner configuration of the linear actuator structure 500 may become neater.

Further, a damping base (not shown) such as the damping base 195 may be included as well. The damping base may be disposed on the driving element 585 and has a central though hole and a limiting slot, wherein the central through hole accommodates the rotating shaft 580, and the limiting slot is fitted by the telescopic antenna, but the present disclosure is not limited thereto.

In one embodiment, when the rotating shaft 580 rotates, the linking screw rod 543 is driven to rotate to synchronously move the second tube 540 and the first tube 520 to lengthen or shorten the linear actuator structure 500. Details of the linear actuator structure 500 will be provided in the following paragraphs.

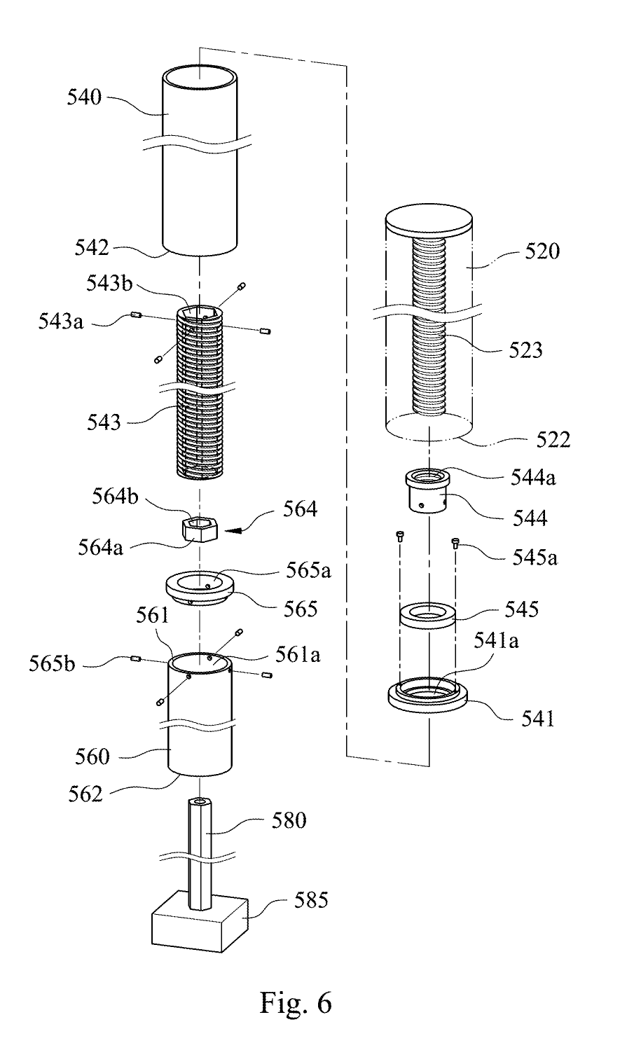

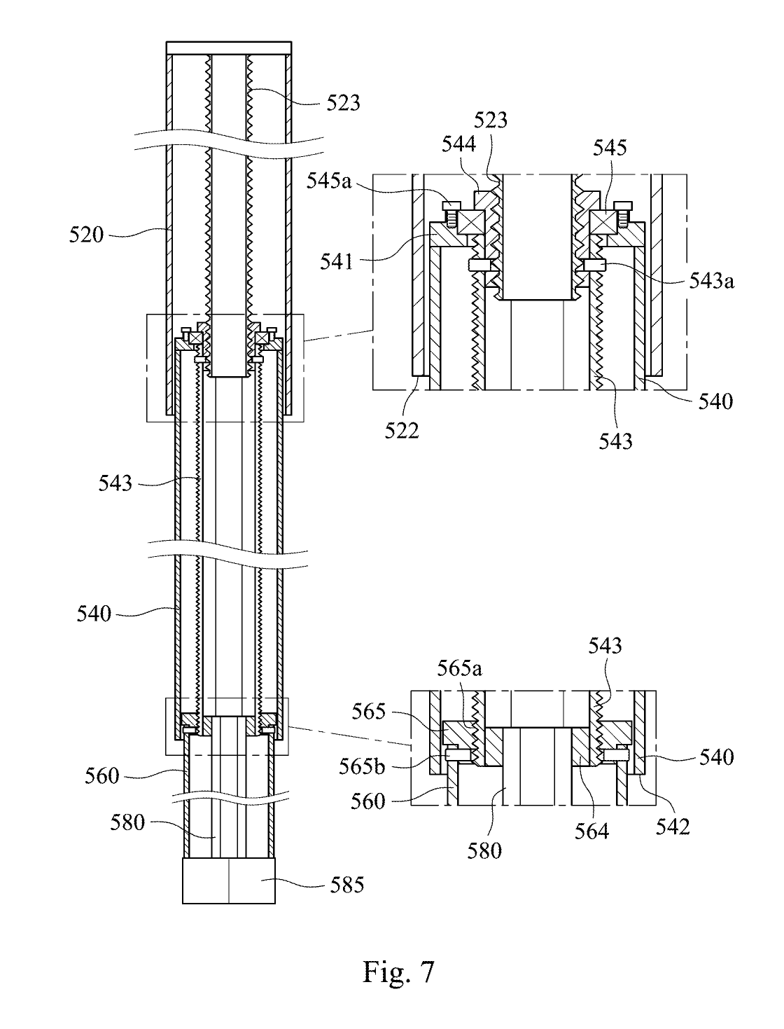

See FIG. 6 and FIG. 7, wherein FIG. 6 is a cross-sectional view of the linear actuator structure 500 according to one embodiment of the present disclosure, and FIG. 7 is an exploded view of the linear actuator structure 500. In FIG. 6 and FIG. 7, the second end 522 of the first tube 520 may be opened, and the first end 561 of the second tube 560 is sleeved by the first tube 520 via the second end 522 of the first tube 520. The first end 541 of the second tube 540 may be disposed with a first opening 541a for the central screw rod 523 to penetrate through.

In the present embodiment, a transition element 544 may be further included. The transition element 544 (which may be regarded as a connecting sleeve) has an inner thread 544a that can be screwed by the central screw rod 523, wherein one end of the transition element 544 has a larger diameter, and another end of the transition element 544 has a smaller diameter. The transition element 544 may be engaged with the linking screw rod 543 via plugs 543a after inserting one end of the linking screw rod 543 with the end having the smaller diameter, such that the transition element 544 may be limited on the first end 541 of the second tube 540.

In addition, a bearing 545 may be further included and disposed between the end of the transition element 544 having the larger diameter and the first end 541 of the second tube 540. In one embodiment, the bearing 545 may be fixed to the first end 541 of the second tube 540 via bolts 545a, and the end of the transition element 544 having the smaller diameter may be sleeved by the bearing 545 which is ring-shaped. The bearing 545 may facilitate the rotation of the transition element 544 without abrading the first end 541 of the second tube 540, but the present disclosure is not limited thereto.

In this case, when the linking screw rod 543 is driven by the rotating shaft 580 to rotate, the transition element 544 engaged with the linking screw rod 543 will be correspondingly rotated to make the central screw rod 523 passively screw in or out of the transition element 544.

If the central screw rod 523 is passively screwed in the transition element 544, the first end 521 of the first tube 520 may be regarded as being pulled closer to the first end 541 of the second tube 540, which shortens the linear actuator structure 500. On the other hand, if the central screw rod 523 is passively screwed out of the transition element 544, the first end 521 of the first tube 520 may be regarded as being pushed away from the first end 541 of the second tube 540, which lengthens the linear actuator structure 500.

In FIG. 6 and FIG. 7, the first end 561 of the third tube 560 is sleeved by the second tube 540 via the second end 542 of the second tube 540 and disposed with a second opening 561a.

In one embodiment, the second opening 561a may be disposed with inner thread to be screwed by the linking screw rod 543. However, in the present embodiment, the second opening 561a may be fitted by a sleeve 565 having an inner thread 565a and limited in the second opening 561a. The sleeve 565 may be engaged with the first end 561 of the third tube 560 via plugs 565b. In this case, the sleeve 565 limited in the second opening 561a may be screwed by the linking screw rod 543. In yet another embodiment, the sleeve 565 may be integrally formed with the first end 561 of the third tube 560 for the linking screw rod 543 to screw, but the present disclosure is not limited thereto.

As shown in FIG. 6, the linking screw rod 543 may have a through hole 543b that is polygonal-shaped, and a limiting ring 564 may be further included. The limiting ring 564 has a polygonal outer periphery 564a and a polygonal inner hole 564b, wherein the polygonal outer periphery 564a fits in the through hole 543b of the linking screw rod 543, and the rotating shaft 580 fits in the polygonal inner hole 564b. In the present embodiment, the polygonal inner hole 564b may be hexagonal, and the rotating shaft 580 may be hexagonal, correspondingly, such that the rotating shaft 580 may movably penetrate the linking screw rod 543 via the polygonal inner hole 564b. As such, when the rotating shaft 580 rotates, the limiting ring 564 will be driven to rotate, and the linking screw rod 543 fitted by the limiting ring 564 will be correspondingly rotated as well.

In one embodiment, when the rotating shaft 580 rotates along a first direction (e.g., a clockwise direction) to drive the linking screw rod 543 to rotate, the linking screw rod 543 screws in the third tube 560 and correspondingly brings the second tube 540 toward a shortening direction, and the central screw rod 523 synchronously and passively screws in the linking screw rod 543 and correspondingly brings the first tube 520 toward the shortening direction.

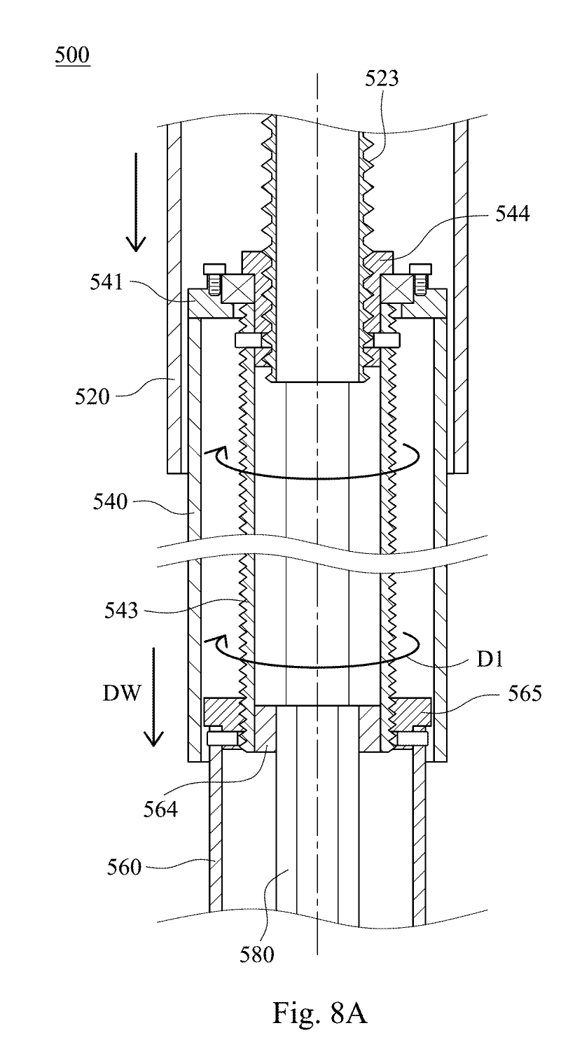

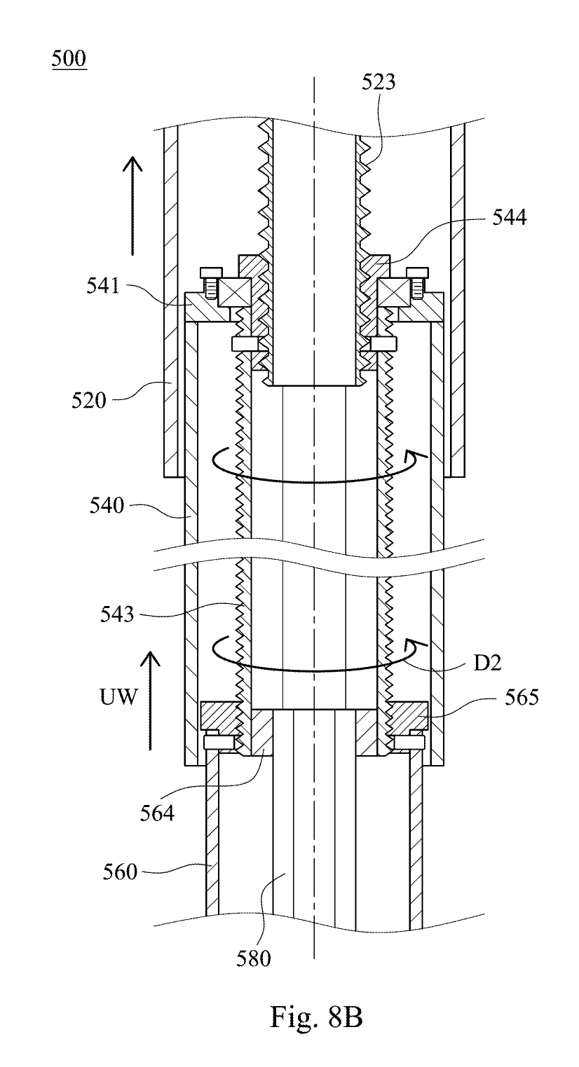

See FIG. 8A for further details, wherein FIG. 8A is a schematic diagram of shortening the linear actuator structure 500. In FIG. 8A, as the linking screw rod 543 is driven to rotate along a first direction D1, it will correspondingly screw the sleeve 565 to move toward a shortening direction DW (e.g., downward). If the linking screw rod 543 moves downward, the rotating shaft 580 may be regarded as passively pushing into the limiting ring 564 (or into the linking screw rod 543). Meanwhile, the first end 541 of the second tube 540 will be driven to move downward along with the downward movement of the linking screw rod 543. Further, when the linking screw rod 543 is driven to rotate, the transition element 544 engaged with the linking screw rod 543 will be correspondingly rotated to make the central screw rod 523 passively screw into the transition element 544 (or into the linking screw rod 543). Correspondingly, the first end (not shown) of the first tube 520 will be driven to move downward.

That is, when the rotating shaft 580 rotates along the first direction D1, the first tube 520 and the second tube 540 will be synchronously moved downward, such that the linear actuator structure 500 may be shortened.

In another embodiment, when the rotating shaft 580 rotates along a second direction (e.g., a counterclockwise direction) to drive the linking screw rod 543 to rotate, the linking screw rod 543 screws out of the third tube 560 and correspondingly brings the second tube 540 toward a lengthening direction, and the central screw rod 523 synchronously and passively screws out of the linking screw rod 543 and correspondingly brings the first tube 520 toward the lengthening direction.

See FIG. 8B for further details, wherein FIG. 8B is a schematic diagram of lengthening the linear actuator structure 500. In FIG. 8B, as the linking screw rod 543 is driven to rotate along a second direction D2, it will correspondingly screw the sleeve 565 to move toward a lengthening direction UW (e.g., upward). If the linking screw rod 543 moves upward, the rotating shaft 580 may be regarded as passively pulled out of the limiting ring 564 (or out of the linking screw rod 543). Meanwhile, the first end 541 of the second tube 540 will be driven to move upward along with the upward movement of the linking screw rod 543. Further, when the linking screw rod 543 is driven to rotate, the transition element 544 engaged with the linking screw rod 543 will be correspondingly rotated to make the central screw rod 523 passively screw out of the transition element 544 (or out of the linking screw rod 543). Correspondingly, the first end 521 of the first tube 520 will be driven to move upward.

That is, when the rotating shaft 580 rotates along the second direction D2, the first tube 520 and the second tube 540 will be synchronously moved upward, such that the linear actuator structure 500 may be lengthened.

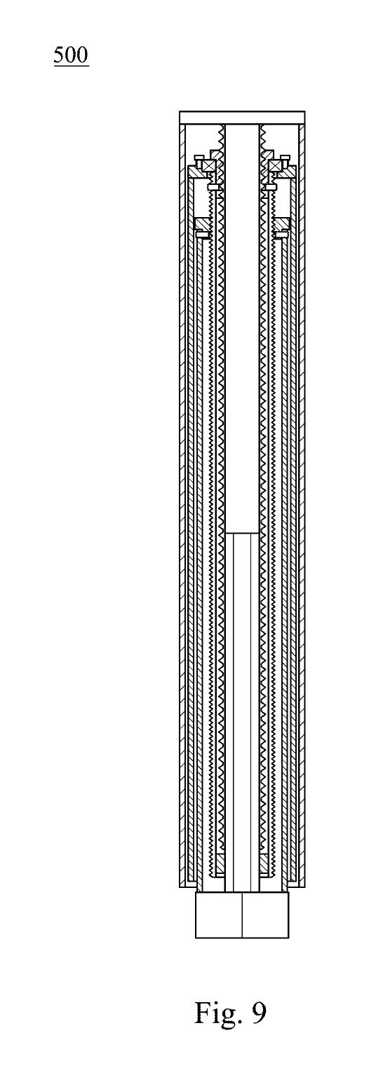

Moreover, in FIG. 5, since the first tube 520 sleeves the second tube 540 via the second end 522 of the first tube 520 and the second tube 540 sleeves the third tube 560 via the second end 542 of the second tube 540, the first tube 520, the second tube 540, and the third tube 560 may be generally regarded as an outer tube, a middle tube, and an inner tube, respectively. In this case, the first tube 520, the second tube 540, and the third tube 560 may be more and more overlapped along with the linear actuator structure being shortened. The linear actuator structure 500 being shortened can be referred to FIG. 9. Alternatively, the first tube 520, the second tube 540, and the third tube 560 may be less and less overlapped along with the linear actuator structure being lengthened.

To sum up, by disposing the linking screw rod, the first tube and the second tube may be synchronously moved to lengthen or shorten the linear actuator structure of the present disclosure. Since the linking screw rod may be driven by a single driving element via the rotating shaft, the overall structure of the linear actuator structure can be simplified and more robust. Besides, since the first tube, the second tube, and the third tube may be more and more overlapped along with the linear actuator structure being shortened, the overall size and cost can be reduced as well. Moreover, by disposing the telescopic antenna to replace conventional electrical lines, the inner configuration of the linear actuator structure can be neater.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A linear actuator structure, comprising:
a first tube having a first end, a second end, and a central screw rod, wherein the central screw rod is disposed in the first tube and engaged to the first end of the first tube;
a second tube having a first end, a second end, and a linking screw rod, wherein the linking screw rod is disposed in the second tube and against the first end of the second tube, and the linking screw rod is linked-up with the central screw rod penetrating the linking screw rod via the second end of the first tube and the first end of the second tube;
a rotating shaft linked-up with the linking screw rod; and
a third tube having a first end and a second end, wherein the first end of the third tube is screwed by the linking screw rod penetrating the second end of the second tube, and the second end of the third tube sleeves the rotating shaft;
wherein when the rotating shaft rotates, the linking screw rod is driven to rotate to synchronously move the second tube and the first tube to lengthen or shorten the linear actuator structure.

2. The linear actuator structure of claim 1, wherein the second end of the first tube is opened and sleeves the first end of the second tube, and the second end of the second tube is opened and sleeves the first end of the third tube.

3. The linear actuator structure of claim 1, further comprising a transition element disposed between the first end of the second tube and the linking screw rod, engaged with the linking screw rod, and screwed by the central screw rod penetrating the second end of the first tube and the first end of the second tube.

4. The linear actuator structure of claim 3, further comprising a bearing disposed between the transition element and the first end of the second tube.

5. The linear actuator structure of claim 3, wherein the transition element comprises:
a connecting sleeve which is hollowed and has an inner thread portion screwed by the central screw rod; and
a circular cap disposed at the first end of the second tube and engaged with the linking screw rod, wherein the circular cap limits the connecting sleeve.

6. The linear actuator structure of claim 5, further comprising a bearing disposed between the connecting sleeve and the circular cap.

7. The linear actuator structure of claim 1, further comprising a driving element for the rotating shaft to dispose thereon, and the second end of the third tube is fixed to the driving element for the rotating shaft to rotate in the third tube.

8. The linear actuator structure of claim 7, further comprising a telescopic antenna sleeved by the third tube and having a first end and a second end, wherein the first end of the telescopic antenna is connected with the driving element, the second end of the telescopic antenna is connected with the first end of the first tube, and the telescopic antenna is shortened or lengthened along with the linear actuator structure shortens or lengthens.

9. The linear actuator structure of claim 8, further comprising a damping base disposed on the driving element and having a central though hole and a limiting slot, wherein the central through hole accommodates the rotating shaft, and the limiting slot is fitted by the telescopic antenna.

10. The linear actuator structure of claim 1, further comprising a transition bolt connected between the rotating shaft and the linking screw rod, wherein the transition bolt has a head portion, a thread portion, and a through hole;
wherein the thread portion screws in the linking screw rod for the head portion to abut the linking screw rod, the through hole is polygonal-shaped, and the rotating shaft movably penetrates and fits the through hole.

11. The linear actuator structure of claim 1, wherein when the rotating shaft rotates along a first direction to drive the linking screw rod to rotate, the linking screw rod screws in the third tube and correspondingly brings the second tube toward a shortening direction, and the central screw rod synchronously and passively screws in the linking screw rod and correspondingly brings the first tube toward the shortening direction.

12. The linear actuator structure of claim 11, wherein when the rotating shaft rotates along a second direction to drive the linking screw rod to rotate, the linking screw rod screws out of the third tube and correspondingly brings the second tube toward a lengthening direction, and the central screw rod synchronously and passively screws out of the linking screw rod and correspondingly brings the first tube toward the lengthening direction.

13. The linear actuator structure of claim 1, wherein the linking screw rod has a through hole that is polygonal-shaped, and the linear actuator structure further comprising:
a limiting ring having a polygonal outer periphery and a polygonal inner hole, wherein the polygonal outer periphery fits in the through hole of the linking screw rod, and the rotating shaft fits in the polygonal inner hole; and
a sleeve engaged with the first end of the third tube and having an inner thread portion screwed by the linking screw rod.

14. A linear actuator structure, comprising:
a first tube having a first end, a second end, and a central screw rod, wherein the second end of the first tube is opened, and the central screw rod is disposed in the first tube and engaged to the first end of the first tube;
a second tube having a first end, a second end, a hollowed screw rod, and a first transition element, wherein the first end of the second tube is sleeved by the first tube via the second end of the first tube and disposed with a first opening, the hollowed screw rod is disposed in the second tube and connected with the first end of the second tube via the first transition element screwed by the central screw rod penetrating the hollowed screw rod via the first opening, and the second end of the second tube is opened;
a driving element having a rotating shaft disposed therein, wherein the rotating shaft penetrates the hollowed screw rod via the second end of the second tube and drives the hollowed screw rod to rotate therewith; and
a third tube having a first end and a second end, wherein the first end of the third tube is sleeved by the second tube via the second end of the second tube and disposed with a second opening screwed by the hollowed screw rod, the second end of the third tube is fixed to the driving element for the rotating shaft to rotate in the third tube;
wherein when the rotating shaft rotates, the hollowed screw rod is driven to rotate to synchronously move the second tube and the first tube to lengthen or shorten the linear actuator structure.

15. The linear actuator structure of claim 14, further comprising a bearing disposed between the first transition element and the first end of the second tube.

16. The linear actuator structure of claim 14, further comprising a telescopic antenna sleeved by the third tube and having a first end and a second end, wherein the first end of the telescopic antenna is connected with the driving element, the second end of the telescopic antenna is connected with the first end of the first tube, and the telescopic antenna is shortened or lengthened along with the linear actuator structure shortens or lengthens.

17. The linear actuator structure of claim 16, further comprising a damping base disposed on the driving element and having a central though hole and a limiting slot, wherein the central through hole accommodates the rotating shaft, and the limiting slot is fitted by the telescopic antenna.
